(19) United States
(12) Patent Application Publication
(10) Pub. No.: US 2006/0000126 A1
(43) Pub. Date: Jan. 5, 2006

(54) Method and apparatus for finding missing individuals

(76) Inventor: Dennis J. Bair, Munhall, PA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 11/189,100

(22) Filed: Jul. 25, 2005

Related U.S. Application Data
(63) Continuation of application No. 10/081,434, filed on Feb. 22, 2002, now abandoned.
(60) Provisional application No. 60/271,066, filed on Feb. 23, 2001.

(51) Int. Cl. G09F 1/00

(52) U.S. Cl. 40/124.01; 340/573.1

(57) ABSTRACT

An apparatus for facilitating to locate a missing person comprising a body containing a writing surface, wherein the body containing the writing surface has a front side and a back side, indicia relating to a missing person and an area for an autograph portion. The apparatus also has an area for a reward portion and sponsor portion. The present invention also is a method for assisting to locate a missing person using the above-described apparatus.

### CROSS REFERENCE TO RELATED APPLICATIONS

The present invention claims the benefit of U.S. patent application Ser. No. 10/081,434, filed Feb. 22, 2002 entitled “Method and Apparatus for Finding Missing Individuals,” which is hereby incorporated herein by reference in its entirety.

The present invention claims the benefit of U.S. Provisional Patent Application Ser. No. 60/271,066, filed Feb. 23, 2001 entitled “Method and Apparatus for Finding Lost Individuals,” which is hereby incorporated by reference in its entirety.

### BACKGROUND OF THE INVENTION

1. Field of the Invention

The present invention relates to an apparatus and method for assisting to locate and find missing people, particularly children.

2. Description of Related Art

Nothing is more disturbing than learning about a missing child. However, many individuals want to help to find that missing child. It has been found that the success rate of finding missing children is very low. In the past, missing children's pictures have been placed on milk cartons or have been distributed through mailings. It has been found that such methods of distributing the missing child's picture have had very little impact on actually finding the child. It has been discovered that by placing a reward for information leading to the location of a missing child has improved the odds of finding that missing child. However, after a short period of time even this information may not yield favorable results. Therefore, it is an object of the present invention to provide an apparatus and method for improving the chances of finding a missing person, particularly that of a missing child.

### SUMMARY OF THE INVENTION

The present invention is an arrangement for disseminating information about a missing child so as to improve the odds of finding the missing child. Particularly, the present invention includes a body, such as a card or paper sheet, containing a writing surface that includes a reward section, a sponsor section, an autograph section and a missing person's section. The body includes a photograph, picture or sketch of the missing person and vital statistics as well as other pertinent information about the missing person. Further, the present invention is a method for assisting to locate and find a missing person by providing reward information on a single card, piece of paper, or other printable material, providing an autograph portion for receiving an autograph from an individual, such as a famous person or sports figure, providing sponsorship information, and providing a photograph and vital statistic information about the missing person.

### BRIEF DESCRIPTION OF THE DRAWING

FIG. 1 is a plan view of a card made in accordance with one embodiment of the present invention.

### DESCRIPTION OF THE PREFERRED EMBODIMENT(S)

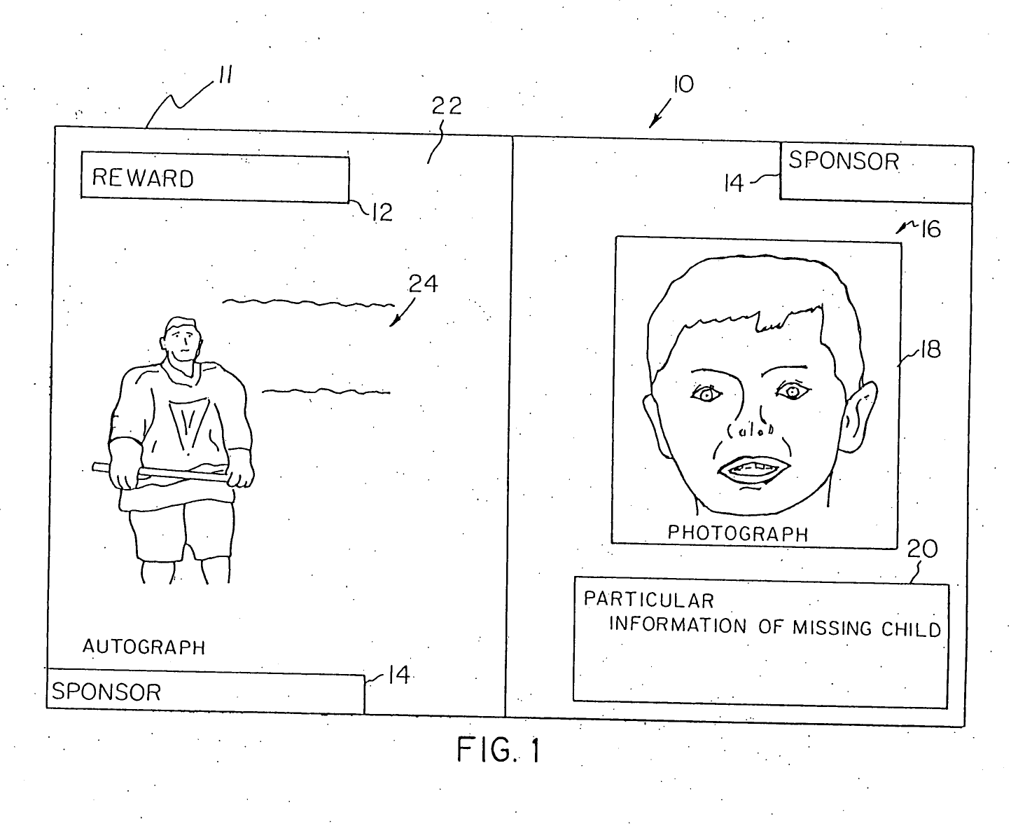

FIG. 1 illustrates one embodiment of the present invention. The apparatus for facilitating to locate a missing person 10, includes a body 11, which can be a card or a paper sheet, has a first side with a writing surface and a second side. The second side (not shown) of the body 11 can be the same as the first side or can have an adhesive coating or a magnetic surface. The body 11 includes indicia relating to the missing person 16, such as the missing person's picture, sketch or photograph 18, and their vital statistics. The indicia relating to the missing person includes an area for information relating to vital statistics 20 includes not only information relating to physical characteristics of the missing person, such as height, weight, age, but also the person's name, age, address and the date that the person has been missing. The area for information relating to vital statistics 20 can also include information about who and where to contact regarding information about the missing person.

In addition, the body 11 has an area for information relating to a reward 12. The area for information relating to the reward 12 identifies the type and amount of the reward being offered for information relating to a missing person, such as a child. Also, an area for information relating to a sponsor 14 identifies a sponsor who is providing the reward, such as money. The sponsor can be a company, an association or an individual. Examples of sponsors include local sports teams, rock bands, and/or soft drink manufacturers or distributors. The area for information relating to a sponsor 14 can also be utilized to display sponsor banners and logos.

The body 11 also includes an area for an autograph portion 22. The area for the autograph portion 22 includes an area in which an individual, or a famous person, such as a sports figure or entertainer, can provide their signature or autograph 24 and their photograph. In this manner, it is believed that the information and picture of the missing person, for example a child, will be remembered by the recipient of the autograph 24, and not be likely to be displaced or discarded as quickly as, for example, if the missing person portion is provided on a milk carton or a flyer in the mail.

In operation, the body 11 can be provided at any function or sporting event, such as a baseball game. Various sports figures, such as baseball players, can be present to sign the body 11 with their autograph 24 and their photograph in the area for an autograph portion 22 with the likeness of the missing person and the vital statistics and physical characteristics of the missing person preprinted on the body 11. Also, the body 11 identifies the amount of the reward in the area for information relating to the reward 12 and the sponsor information, such as a company, association or individual who is finding the reward in the area for information relating to the sponsor 14. Also, during the sporting event, the particular missing person's picture could be displayed throughout the stadium on the large screens or scoreboards that are typically provided at a sports stadium. It is believed that once the patrons leaving the stadium who receive the body 11 will place the body 11 in a noticeable spot such as on the front of a refrigerator or on a bulletin board or desk. The missing person's photograph will be a constant reminder to aid the patrons in remembering the appearance of the missing person. It is believed that the present invention will increase the chances of a patron, who received the body 11, to recognize or notice the missing person than if no reward and/or autograph were present. It is believed that if only the missing person's photograph 18 is passed out at the sporting event, that the missing person's photograph 18 and vital statistics would be discarded and would not increase the chances of locating the missing person and would have a similar result as providing this information on a milk carton. Another aspect of the invention is to provide a piece of writing material having a portion for autographs and sponsorship indicia applied thereon.

While a specific embodiment of the invention has been described in detail, it will be appreciated by those skilled in the art that various modifications and alternatives to those details could be developed in light of the overall teachings of the disclosure. The presently preferred embodiment described herein is meant to be illustrative only and not limiting as to the scope of the invention which is to be given the full breadth of the appended claims and any and all equivalents thereof.

The invention claimed is:

1. An apparatus for facilitating to locating a missing person comprising a body containing a writing surface, wherein the body has a first side and a second side and the writing surface is on the first side, and includes on a first section of the writing surface, the missing person's photograph above an area for indicia relating to a missing person, including vital statistics, a date indicating how long the person has been missing, and contact information and another area on a second section of the writing surface for an autograph portion to attract viewers and add intrinsic value to the card, wherein the autograph portion contains an area for the individual's autograph positioned below an individual's photograph, which is different than that of the missing person.

2. The apparatus for facilitating to locate a missing person according to claim 1, wherein the body further comprises an area for information relating to a reward.

3. The apparatus for facilitating to locate a missing person according to claim 1, wherein the body further comprises an area for information relating to a sponsor.

4. The apparatus for facilitating to locate a missing person according to claim 1, wherein the indicia relating to the missing person is chosen from the group consisting of a picture, a photograph or a sketch of the missing person.

5. The apparatus for facilitating to locate a missing person according to claim 1, wherein the indicia relating to the missing person includes vital statistics and physical characteristics of the missing person.

6. The apparatus for facilitating to locate a missing person according to claim 2, wherein the area for information relating to the reward identifies an amount of the reward.

7. The apparatus for facilitating to locate a missing person according to claim 3, wherein the area for information relating to the sponsor includes a sponsor's logo or banner.

8. The apparatus for facilitating to locate a missing person according to claim 1, wherein the body comprises a card or a paper sheet.

9. The apparatus for facilitating to locate a missing person according to claim 1, wherein the second side is a magnet or includes an adhesive coating.

10. The apparatus for facilitating to locate a missing person according to claim 1, wherein the body has an area for information relating to a reward and an area for information relating to a sponsor.

11. A method for assisting to locate a missing person, comprising the steps of:
providing a body;
providing a likeness of the missing person on the body;
providing vital statistic information of the missing person on the body;
providing reward information on the body;
providing sponsorship information on the body;
providing an autograph portion on the body, wherein the autograph portion contains an area for an autograph of an individual and the individual's photograph, which is different than that of the missing person; and
subsequent to providing an autograph portion on the body, providing a handwritten autograph in the area for an autograph of an individual to attract viewers and add intrinsic value to the card.

12. The method for assisting to locate a missing person according to claim 11, wherein the reward information includes a reward amount.

13. The method for assisting to locate a missing person according to claim 11, wherein the likeness of the missing person is chosen from the group consisting of a picture, a photograph or a sketch of the missing person.

14. The method for assisting to locate a missing person according to claim 11, wherein the vital statistic information of the missing person includes the physical characteristics of the missing person.

15. The method for assisting to locate a missing person according to claim 11, wherein the sponsorship information includes a name of a company, association, or individual.
